(19) United States
(12) Patent Application Publication
(10) Pub. No.: US 2019/0139033 A1
(43) Pub. Date: May 9, 2019

(54) METHOD FOR REAL-TIME CONVERSION OF CRYPTOCURRENCY TO CASH AND OTHER FORMS OF VALUE AT THE POINT OF USE

(71) Applicant: BurstIQ Analytics Corporation, Colorado Springs, CO (US)

(72) Inventors: Frank Ricotta, Colorado Springs, CO (US); Brian Jackson, Parker, CO (US); Tyson Henry, Castle Rock, CO (US); Amber Mortensen Hartley, Lakewood, CO (US); Michael Gionfriddo, Frisco, CO (US)

(21) Appl. No.: 16/184,757

(22) Filed: Nov. 8, 2018

Related U.S. Application Data
(60) Provisional application No. 62/583,436, filed on Nov. 8, 2017.

(51) Int. Cl. G06Q 20/38; G06Q 20/06; G06Q 20/36

(52) U.S. Cl. CPC G06Q 20/381; G06Q 20/389; G06Q 20/3223; G06Q 20/3678; G06Q 2220/00; G06Q 20/0658

(57) ABSTRACT

Systems and methods move money from a crypto currency to a fiat currency in real-time using a mobile wallet or debit card to allow a customer to use the funds instantly. The process for such movement of money is secured using distributed ledger technology and smart contract services. The funds are available to the customer in real-time and the customer is able to use those funds substantially anywhere credit cards are accepted and at substantially any automatic teller machine (ATM). A multi-layered distributed ledger and reconciliation method may be used as a transaction settlement system. The multi-tiered authentication and distributed identification method may be used to prevent fraud and theft. A retail transactional value of a portfolio of digital currencies may be determined by taking into account asset market liquidity and volatility.

### RELATED APPLICATIONS

This application claims priority to U.S. Patent Application Ser. No. 62/583,436, titled “Method for Real-Time Conversion of Cryptocurrency to Cash and Other Forms of Value at the Point of Use,” filed Nov. 8, 2017, and incorporated herein by reference.

### FIELD OF THE INVENTION

This invention relates to the mobile payments/digital currencies/cryptocurrency/financial services industry. Specifically, this invention relates to converting monetary value stored as digital currencies and cryptocurrency to cash and other forms of value in real-time within a transactional mobile commerce system.

### SUMMARY

A system and method convert monetary value stored as digital currencies and cryptocurrency to cash and other forms of value in real-time within a transactional mobile commerce system using distributed ledger technology and smart contract services.

In a first aspect, a method moves money from a crypto currency to a fiat currency in real-time using a mobile wallet or debit card to allow a customer to use the funds instantly.

In certain embodiments of the first aspect, the process for such movement of money is secured using distributed ledger technology and smart contract services.

In certain embodiments of the first aspect, the funds are available to the customer in real-time and the customer is able to use those funds substantially anywhere credit cards are accepted and at substantially any automatic teller machine (ATM).

Certain embodiments of the first aspect further include using a multi-layered distributed ledger and reconciliation method as a transaction settlement system.

In a second aspect, a method for multi-tiered authentication and distributed identification prevents fraud and theft.

In a third aspect, a method determines a retail transactional value of a portfolio of digital currencies by taking into account asset market liquidity and volatility.

### BRIEF DESCRIPTION OF THE FIGURES

FIG. 1 introduces the concept of Crypto Wallet, in an embodiment.

FIG. 2 shows a system of layered accounts for all users, in an embodiment.

FIG. 3 shows a system of layered authentication and distributed identities between components of value representation and stored value, in an embodiment.

FIG. 4 shows real-time conversion from a Cybercurrency Wallet to a user's Fiat Currency Wallet, in an embodiment.

FIG. 5 shows loading of a debit card account from the funds in a user's Fiat Wallet, in an embodiment.

FIG. 6 shows real-time loading of debt card account during the flow of an Authorization Transaction from a card network, in an embodiment.

FIG. 7 shows how the Intelligent Balance Service would interact with Service Providers to create a dynamic balance based on value of the different values based on a user's Cybercurrency Wallets, in an embodiment.

### DETAILED DESCRIPTION OF THE EMBODIMENTS

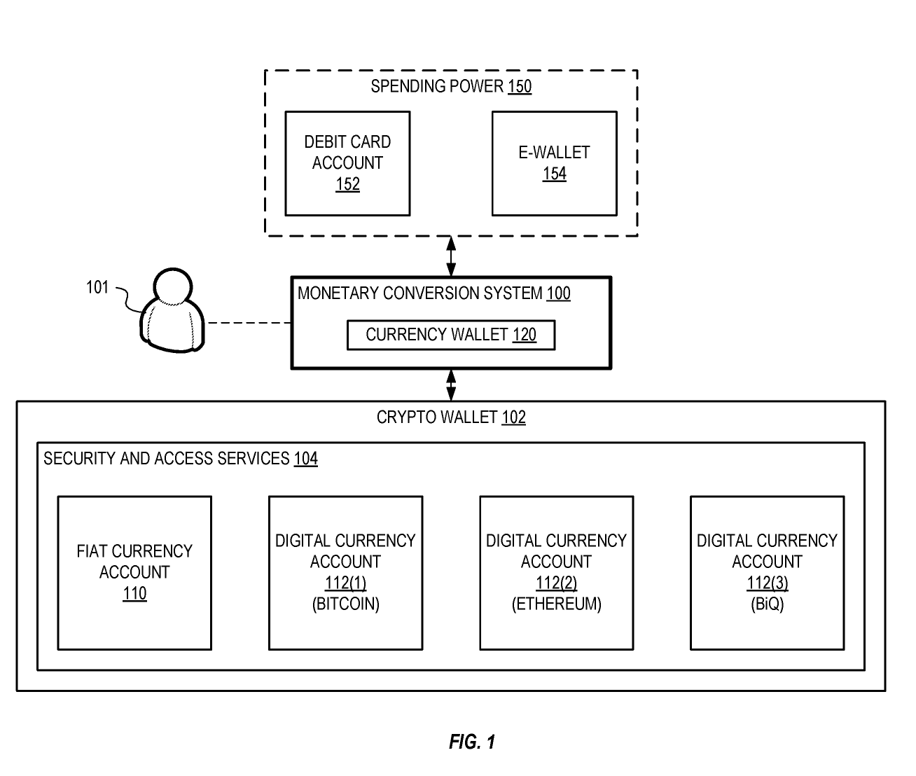

FIG. 1 introduces the concept of a crypto wallet 102 (may also referred to as a cryptocurrency wallet). The crypto wallet 102 may be of the type selected from the group including online, mobile, desktop, hardware and paper wallets. The crypto wallet 102 may include one or more fiat currency accounts 110 (e.g., US dollars, Euros, etc.) and one or more digital currency accounts 112(1)-112(3) (e.g., cryptocurrencies such Bitcoin, Ethereum, and BIQ). The digital currency account 112 (also referred to as crypto currency herein) is a type of currency available in digital form, and that may not have a physical form (such as banknotes and coins). Although crypto wallet 102 is shown with one fiat currency account 110 and three digital currency accounts 112, the crypto wallet 102 may contain more fiat currency accounts 110 and/or fewer or more digital currency accounts 112 without departing from the scope of the embodiments described herein.

As disclosed herein, a monetary conversion system 100 may exchange funds on the fly (e.g., in real-time) between the digital currency accounts 112 and the fiat currency accounts 110 to provide the owner 101 of the crypto wallet 102 with spending power 150 based upon funds stored in the crypto wallet 102. Accordingly, the monetary conversion system 100 may use a currency wallet 120 to associate and connect the crypto wallet 102 with one or more financial instruments, such as the debit card account 152 and/or the e-wallet 154.

The monetary conversion system 100 uses security and access services 104 associated with the crypto wallet 102, and implements a layered distributed ledger (described in detail below) for the currency wallet 120, to exchange currencies within currency accounts 110, 112 contained within the crypto wallet 102 to provide the spending power 150 to the owner 101 of the crypto wallet 102. A value of the crypto wallet 102 may be computed by the monetary conversion system 100 based on current market values of each of the currencies held within the crypto wallet 102.

In particular, the monetary conversion system 100 may convert at least part of the funds of the digital currency account 112 in real-time (e.g., on the fly) to the fiat currency account 110 to enable purchase of virtual or physical goods and services at point-of-sale terminals. For example, the monetary conversion system 100 may allow the owner 101 to obtain fiat currency cash at an automatic teller machine (ATM) from funds stored within the crypto wallet 102 and converted to funds accessible via one or both of the debit card account 152 and/or the e-wallet 154.

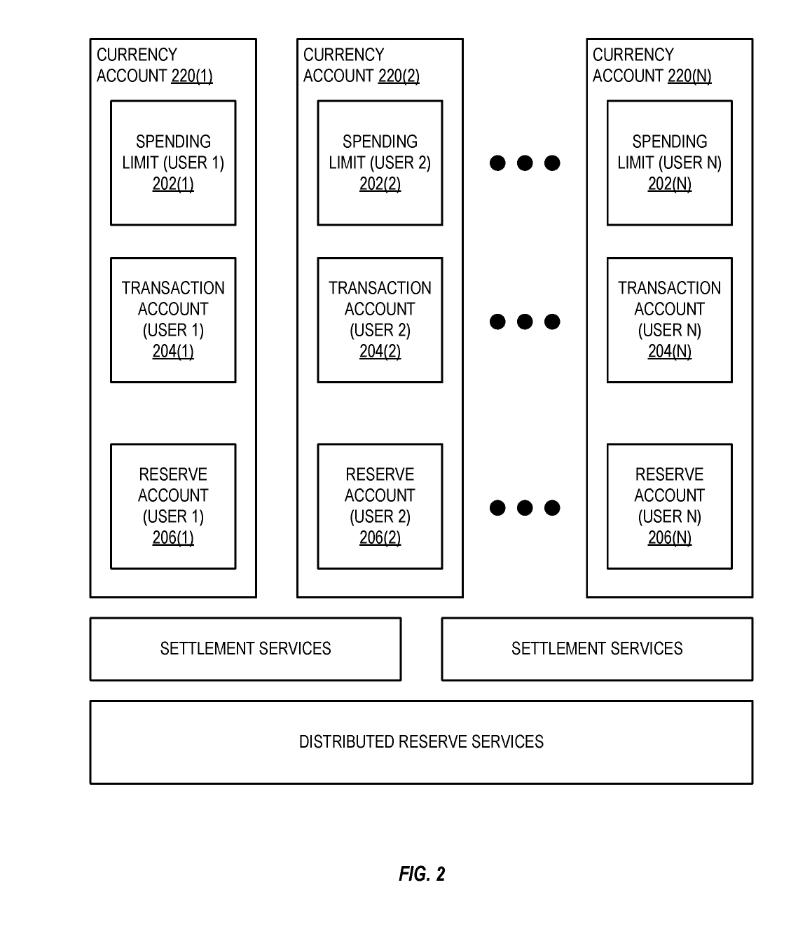

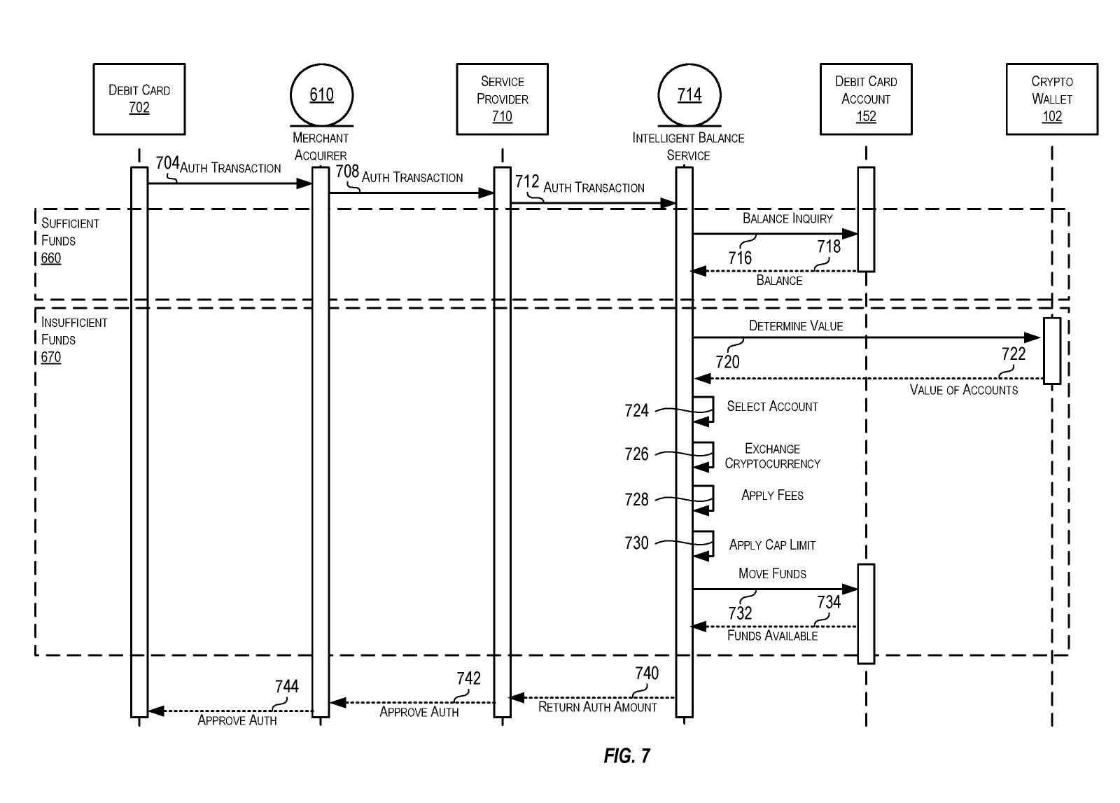

FIG. 2 shows a plurality of currency accounts 220(1)-220(N), each associated with a crypto wallet 102. The monetary conversion system 100 uses a multi-layered distributed ledger to create and manage each currency wallet 120. Each currency wallet may include a spending limit 202, a transactional account 204 and a reserve account 206, that collectively support the real-time conversion and transaction of digital currencies 112 to and from fiat currency account 110. For example, where the owner 101 visits a store and makes a purchase, the monetary conversion system 100 may convert funds from one or more digital currencies 112 into the fiat currency account 110 for use at the store. Each currency wallet 120 operates with an independent ledger and maintains a balance as determined interaction with the Intelligent Balance Service 714 (FIG. 7). Given a set of inputs, constraints, and currency values, the Intelligent Balance Service 714 provides a spendable balance which may be represented in fiat currency. In one embodiment, a Reserve Account 206 is used when a person wishes to purchase crypto currency to convert to fiat currency. The value of Reserve Account 206 may be a calculated amount, a user-directed amount, or may be determined by other methods. The Spending Limit 202 may be calculated as the value of Transaction Account 204 minus the value of Reserve Account 206. Spending limit 202 is the amount a user has available to use for commerce activities.

FIG. 2 shows Settlement Services, which may settle transactions across multiple Currency Wallets 120. For example, the process to load a debit card with funds may take longer than the time available to complete a transaction, in which case, the settlement services may handle completion of the transaction and update appropriate balances after completion of such transaction. In one embodiment, Distributed Reserve Services may provide a pool of funds that allow settlement services to complete a transaction in the absence of sufficient funds in Reserve Account 206.

Transactions at each level of the currency wallet 120 may be governed by a multi-level authentication and encryption method, an example of which is described in patent application Ser. No. 16/031,929, incorporated herein by reference. Through use of the multi-level authentication and encryption method, fraud may be eliminated and a framework is provided to support various geographic financial regulations.

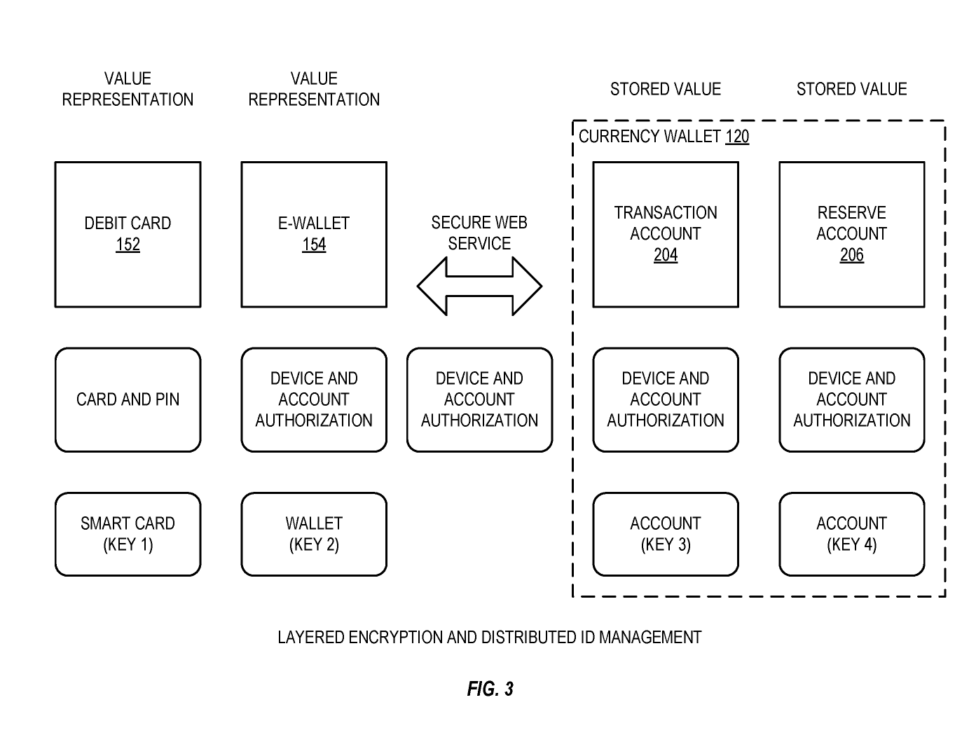

FIG. 3 is a schematic diagram showing layered encryption and distributed ID management that may be implemented by the monetary conversion system 100 of FIG. 1. FIGS. 1 through 3 are best viewed together with the following description: Through layered encryption and distributed ID management, value representation (e.g., debit card account 152 and/or e-wallet 154) and stored value (e.g., values in transaction accounts 204 and reserve accounts 206) are balanced and maintained. Account identification and authorization is managed through device and account authorization contained in the currency wallet 120 and that are embedded in the multi-layered distributed ledger implemented by the security and access services 104. Each e-wallet 154 and currency wallet 120 has a unique anonymous public and private key. The public key provides the basis for the underlying ID for currency accounts 110, 112, 220. The methods depicted in FIG. 3 provide extended account management features capable of securing, storing, and protecting identifiable attributes such as name, address, phone, email, and other attributes for each of the currency wallets 120 (e.g., the account of the owner 101) to be fully compliant with local regulatory requirements.

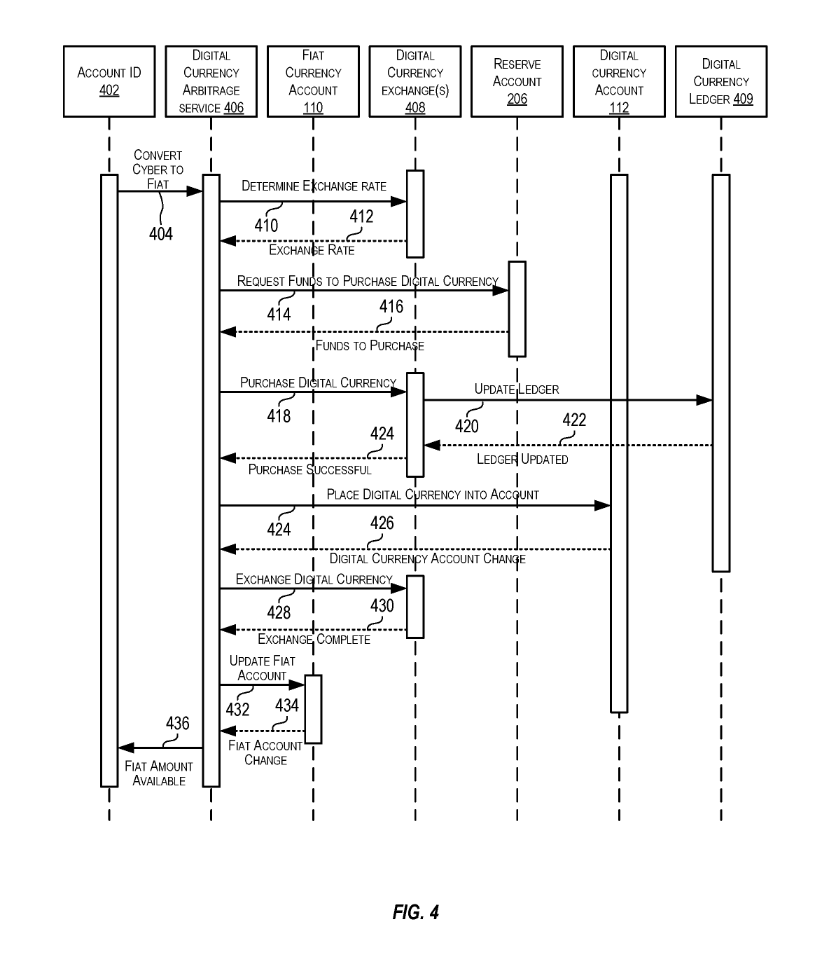

FIG. 4 shows example transaction steps and communications for real-time conversion and transfer of funds from digital currency account 112 to fiat currency account 110, for the currency wallet 120 of FIG. 1, to provide the spending power 150 for the owner 101 of the currency wallet 120. For example, this conversion facilitates the loading of a stored-value payment instrument (e.g., the debit card account 152 and/or the e-wallet 154) that allows the owner 101 of the currency wallet 120 to easily use their digital currency account 112 in conventional retail or ecommerce transactions.

In the example of FIG. 4, the owner 101 of the currency wallet 120 wishes to make a purchase using digital currency funds (e.g., one of Bitcoin, Ethereum, and BIQ of digital currencies 112(1)-112(3), respectively). The owner 101 provides an account ID 402, identifying the currency wallet 120 corresponding to the crypto wallet 102 for example, and requests conversion of digital currency account 112 to fiat currency account 110. Accordingly, a conversion request 404 is sent to a digital currency arbitrage service 406 of the monetary conversion system 100. The digital currency arbitrage service 406, based upon the conversion request 404, interacts with at least one digital currency exchange 408 to determine an exchange rate 410 for the digital currency. For example, where the owner 101 wishes to convert bitcoin, the digital currency exchange 408 may deal in bitcoin and provide the exchange rate 412 based upon current market exchange values for Bitcoin. The digital currency arbitrage service 406 then requests 414 funds from the reserve account 206 to purchase the digital currency, and receives funds to purchase 416 from the reserve account 206. The digital currency arbitrage service 406 then purchases 418 the digital currency from the digital currency exchange 408 and the digital currency ledger 409 is updated 420 and confirmed 422. When the digital currency exchange 408 confirms that the purchase is successful 424, the digital currency arbitrage service 406 places 424 the purchased digital currency into the digital currency account 112 and receives confirmation 426. The digital currency arbitrage service 406 then initiate an exchange of digital currency 428 with the digital currency exchange 408 and received a confirmation of exchange complete 430. The digital currency arbitrage service 406 then updates 432 the fiat currency account 110 with the converted amount and received a fiat account change 434 confirmation. The digital currency arbitrage service 406 may then indicates that the fiat amount is available 436. Accordingly, funds from the digital currency account 112 are converted into fiat currency account 110 and may be loaded into the debit card account 152 and/or the e-wallet 154.

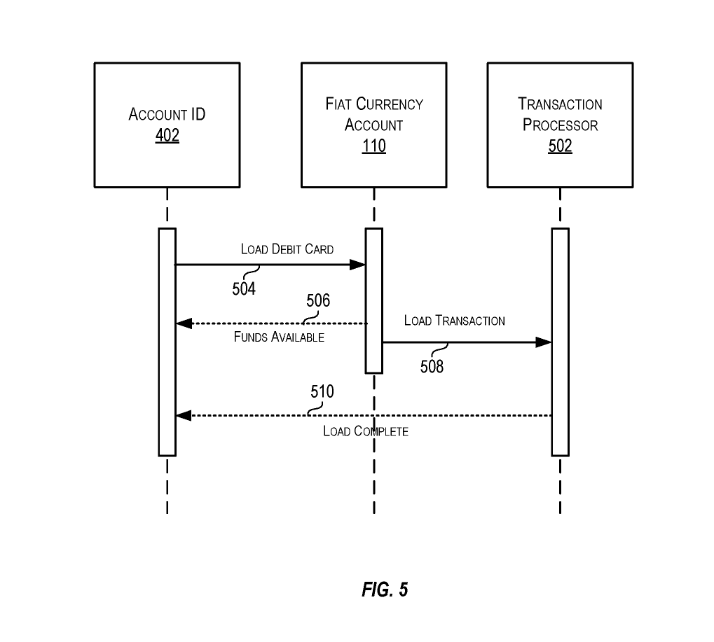

FIG. 5 shows loading of the debit card account 152 from the fiat currency account 110 funds in the crypto wallet 102 of the owner 101. When the owner of the crypto wallet 102 desires to use their digital currency account 110 at a retail location, they may do so in one of two ways. Where the retail location (e.g., POS terminal, online store etc.) supports use of the digital currency account 112, the owner 101 may transfer funds from the digital currency account 112 of the cyber wallet 102 to complete the transaction. Alternatively, where the retail location does not allow use of digital currency, the owner 101 may move funds from the crypto wallet 102 to a stored value instrument such as the debit card account 152 using a web interface or mobile application. For example, the owner 121 may instruct the monetary conversion system 100 to convert funds from the digital currency account 112(1) (e.g., Bitcoin) into the fiat currency account 110 (e.g., US dollars), and then to move the funds from the fiat currency account 110 to the debit card account 152 and/or the e-wallet 154. All funds in the debit card account can then be used anywhere a credit card or debit card can be used, such as in any ATM around the world. Conversely, funds may also be moved from the debit card account 152 and/or the e-wallet 154 to the crypto wallet 102 and stored in the fiat currency account 110 and/or converted into digital currency and stored in one or more of the digital current accounts 112.

As shown in FIG. 5, based upon an account ID 402 that identifies the currency wallet 120 of the owner 101, a load debit card request 504 is initiated for the account, and a response 506 indicates whether there are sufficient funds in the fiat currency account 110. When there are sufficient funds in the fiat currency account 110, a load transaction 508 is sent to an external transaction processor 502 and a load complete indication 510 is received to indicate that the funds are loaded into the debit card account 152.

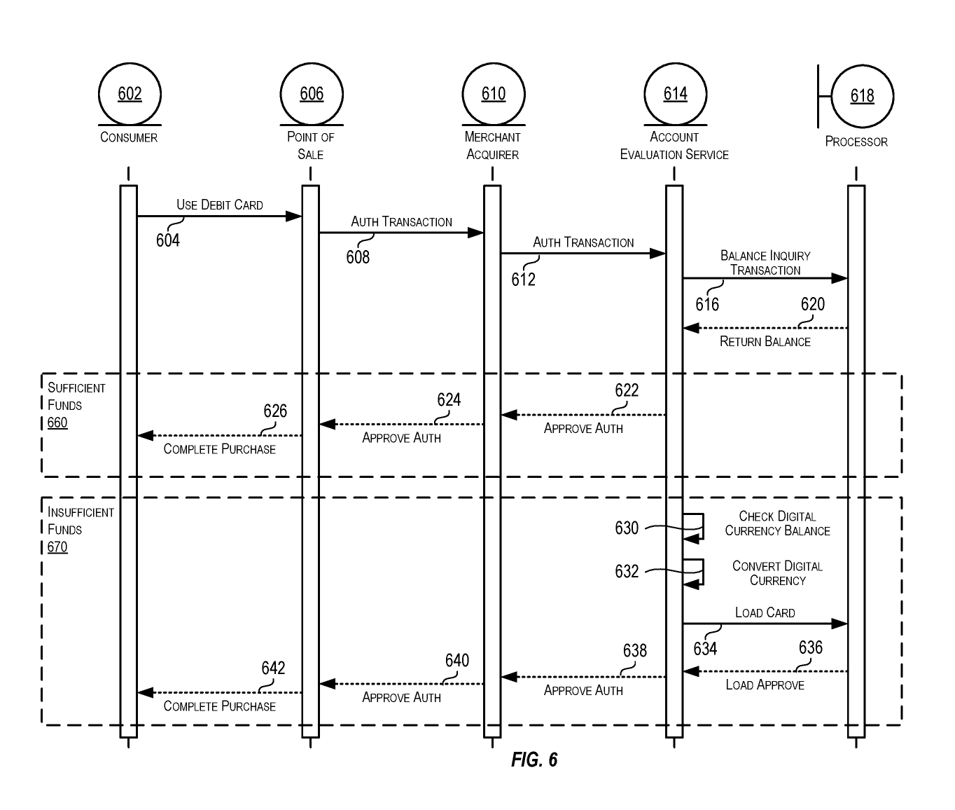

FIG. 6 shows transaction steps for purchasing goods or services in a retail or ecommerce environment through a card network and illustrating real-time (on-the-fly) conversion of funds from a digital currency account 112 within the crypto wallet 102 to load the debit card account 152 with sufficient funds to complete the transaction by the monetary conversion system 100. For example, the owner 101 may authorize automatic use of funds from the digital currency account 112 to top up the debit card account 152 as needed.

As shown in FIG. 6, the consumer 602 (e.g., the owner 101) uses 604 a debit card at a POS 606, which sends an authorization transaction 608 to a merchant enquire 610 of the card network. The merchant acquirer 610, in turn, sends an authorization transaction 612 to an account evaluation service 614 which issues a balance inquiry transaction to an external transaction processor 618. In response, the transaction processor 618 returns a balance 620 to the account evaluation service 614.

In a first scenario, shown within dashed outline 660, when the account evaluation service 614 determines that there are sufficient funds in the debit card account 152 to complete the transaction, the account evaluation service 614 sends an approve authorization 622 to the merchant acquirer 610. The merchant acquirer 610 then sends an approve authorization 624 to the POS 606, and the purchase is completed 626.

In a second scenario, shown within dashed outline 670, when the account evaluation service 614 determines that there are insufficient funds in the debit card account 152 to complete the transaction, the account evaluation service 614 checks 630 the balance of the digital currency account 112 and converts funds of the digital currency account 112 to funds in the fiat currency account 110. The account evaluation service 614 then instructs the transaction processor 618 to load 634 the debit card account 152 with funds from the fiat currency account 110 and in response receives a load approve 636 from the transaction processor 618. The account evaluation service 614 then sends an approve authorization 638 to the merchant acquirer 610. In response, the merchant acquirer 610 sends an approve authorization 640 to the POS 606, and the purchase is completed 642. Advantageously, funds from the digital currency account 112 of the crypto wallet 102 are converted and transferred when needed to make the purchase and at the time of the purchase.

FIG. 7 shows example transaction steps for a debit card purchase where the debit card account has insufficient funds and illustrates how an intelligent balance service 714 may interact with a service provider 710 to create Spending Limit 202 based on a current value of digital currency accounts 112 within the crypto wallet 102 of the owner 101. In certain embodiments, the service provider 710 (e.g., an issuing bank) may determine spending limit for a stored value instrument (e.g., the debit card 702) based on a current value of the corresponding crypt wallet 102. The service provider 710 and/or the intelligent balance service 714 may utilize one or more complex algorithms that use volatility and liquidity of digital currencies corresponding to the digital currency accounts 112 in the crypto wallet 102.

In the example of FIG. 7, the owner 101 presents a debit card 702 at a POS (e.g., at a POS terminal or at an online retail location) using either a physical card or a mobile wallet service. The POS sends an authorization request 704 to the merchant acquirer 610, which in turn, sends an authorization request 708 to the service provider 710. The service provider 710 then sends an authorization transaction to the intelligent balance server 714 which must be approved by the intelligent balance service 714 before the purchase may be completed.

The intelligent balance service 714 may first send a balance inquiry 716 to the debit card account 152 and receive a balance 718 is response. When the indicated balance 718 is sufficient for the transaction, the intelligent balance service 714 sends a return authorization amount 740 to the service provider 710, which sends an approve authorization 742 to the merchant acquirer 610, which in turn sends an approve authorization 744 to the POS. When the indicated balance 718 is insufficient for the transaction, the intelligent balance service 714 requests 720 (e.g., from the monetary conversion system 100) a determined value of the crypto wallet 102, and receives in response, and receives, in response, a value of accounts 722 (e.g., a current value of each digital currency account 112 in the crypto wallet 102). The intelligent balance service 714 may then select an account 724 (e.g., an appropriate one of the digital currency accounts 12(1)-(3)), apply a cap limit 730 (e.g., set the approval amount to a limit when the funds exceed the limit), exchange cryptocurrency 726 (e.g., funds from the selected digital currency account 112), apply fees 728 (e.g., per transaction fees, currency conversion fees, gas fees or other fees) and then move 732 the funds to the debit card account 152, receiving a funds available indication 734 when the funds are available in the debit card account 152. The intelligent balance service 714 sends a return authorization amount 740 to the service provider 710, which sends an approve authorization 742 to the merchant acquirer 610, which in turn sends an approve authorization 744 to the POS.

Accordingly, the monetary conversion system 100 transfers funds from the crypto wallet 102 to automatically load the debit card account 152 with the appropriate funds in the fiat currency as part of the final authorization and approval process for the POS transaction.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for moving money from a crypto currency to a fiat currency in real-time using a mobile wallet or debit card to allow a customer to use the funds instantly.

2. The method of claim 1, wherein the process for such movement of money is secured using distributed ledger technology and smart contract services.

3. The method of claim 1, wherein the funds are available to the customer in real-time and the customer is able to use those funds substantially anywhere credit cards are accepted and at substantially any automatic teller machine (ATM).

4. The method of claim 1, further comprising using a multi-layered distributed ledger and reconciliation method as a transaction settlement system.

5. A method for multi-tiered authentication and distributed identification to prevent fraud and theft.

6. A method for determining a retail transactional value of a portfolio of digital currencies by taking into account asset market liquidity and volatility.
